(19) United States
(12) Patent Application Publication
(10) Pub. No.: US 2010/0179087 A1
(43) Pub. Date: Jul. 15, 2010

(54) Compressed Detergent Composition

(75) Inventors: Ardite Francesc Ayats, Barcelona (ES); Karl Ludwig Gibis, Limburgerhof (DE); Chris Efstathios Housmekerides, Wassenaar (NL); Axel Halbherr, Ludwigshafen (DE); Frederic Moreux, Barcelona (ES); Rainer Link, Ludwigshafen (DE)

Correspondence Address: PARFOMAK, ANDREW N.;NORRIS MCLAUGHLIN & MARCUS PA, 875 THIRD AVE, 8TH FLOOR, NEW YORK, NY, 10022, US

(73) Assignee: Reckitt Benckiser Production (Poland) sp.z.o.o, Mazowiecki (PL)

(21) Appl. No.: 12/447,618

(22) PCT Filed: Oct. 29, 2007
(86) PCT No.: PCT/GB07/04109

§ 371 Date: Mar. 22, 2010

(30) Foreign Application Priority Data
Oct. 30, 2006 (GB) 0621578.4
Oct. 30, 2006 (GB) 0621580.0
Oct. 30, 2006 (GB) 0621582.6
Sep. 18, 2007 (GB) 0718129.0

(51) Int. Cl. C11D 17/00; B29C 43/34; B29C 43/02

(52) U.S. Cl. 510/445; 425/256; 264/319

(57) ABSTRACT

Methods, apparatus for the manufacture of an elongate compressed detergent composition, using apparatus comprising at least one pressing means (64) in movable communication with a forming chamber (60), wherein said at least one pressing means has a contact surface (65) suitable for contacting, in use, a composition, (61) to be compressed, and wherein the at least one contact surface is angled with respect to the forming chamber; the method comprising the steps of: loading the forming chamber with a dose of the detergent composition; the at least one contact surface being brought into contact with the detergent composition; the at least one pressing means compressing the composition between the at least one contact surface and forming chamber; and retracting the at least one pressing means to leave an elongate compressed detergent composition in the forming chamber of a non-rectangular cross-section.

### FIELD OF THE INVENTION

This invention relates to the preparation of a detergent composition that is suitable for use in a multi-dosing detergent delivery device, and particularly but not exclusively, a device to be used in a dishwashing machine or a laundry washing machine.

### BACKGROUND

Improvements are needed to expensive and slow manufacturing techniques required for the production of a solid detergent composition which is suitable for use in a multi-dosing delivery device.

Accordingly, it is an aim of the present invention to provide methods for manufacturing solid detergent compositions with improved cost-efficiency and/or improved production times in order to provide an inexpensive solid detergent composition suitable for use in a multi-dosing delivery device.

### SUMMARY OF INVENTION

According to a first aspect of the present invention therefore, there is provided a method of manufacture of an elongate compressed detergent composition, using apparatus comprising at least one pressing means in movable communication with a forming, chamber, wherein said at least one pressing means has a contact surface suitable for contacting, in use, a composition to be compressed, and wherein the at least one contact surface is angled with respect to the forming chamber; the method comprising the steps of: loading the forming chamber with a dose of the detergent composition;

the at least one contact surface being brought into contact with the detergent composition;
the at least one pressing means compressing the composition between the at least one contact surface and forming chamber; and
retracting the at least one pressing means to leave an elongate compressed detergent composition in the forming chamber of a non-rectangular cross-section.

For the avoidance of doubt, “cross-section” is used herein to describe a section of the compressed composition defined as substantially at a right angle to the longitudinal axis extending along the length of the elongate composition.

According to a second aspect of the present invention therefore, there is provided a method of manufacture of an elongate compressed detergent composition, using apparatus comprising at least one pressing means in movable communication with a forming chamber, wherein said at least one pressing means has a contact surface suitable for contacting, in use, a composition to be compressed, and wherein the at least one contact surface is angled with respect to the forming chamber; the method comprising the steps of: loading the forming chamber with a dose of the detergent composition;

the at least one contact surface being movable in a substantially horizontal direction to be brought into contact with the detergent composition;
the at least one pressing means compressing the composition between the at least one contact surface and forming chamber; and
retracting the at least one pressing means to leave an elongate compressed detergent composition in the forming chamber of a non-rectangular cross-section.

According to a third aspect of the present invention therefore, there is provided a method of manufacture of an elongate compressed detergent composition, using apparatus comprising at least one pressing means in movable communication with a forming chamber, wherein said at least one pressing means has a contact surface suitable for contacting, in use, a composition to be compressed, and wherein the at least one contact surface is angled, with respect to the forming chamber; the method comprising the steps of: loading the forming chamber with a dose of the detergent composition; the at least one contact surface being brought into contact with the detergent composition;

the at least one pressing means compressing the composition between the at least one contact surface and forming chamber;
retracting the at least one pressing means to leave an elongate compressed detergent composition in the forming chamber; and
wherein at least one pair of opposite elongate sides of the compressed composition are defined by one of said pair of sides being narrower that the other of said pair of sides.

According to a fourth aspect of the present invention therefore, there is provided an elongate compressed detergent composition of a substantially non-rectangular cross-section, whereby the compressed composition is formed by the method according to any of the first-third aspects of the present invention.

Surprisingly, the methods according to the first and/or second and/or third aspects of the present invention provide methods of manufacturing an elongate compressed detergent composition in a shorter period of time and with improved cost-efficiency over existing methods of manufacture.

According to a fifth aspect of the present invention therefore, there is provided an elongate compressed detergent composition wherein at least one pair of the elongate sides of the compressed composition are defined by one of said pair of sides being narrower that the other of said pair of sides; and whereby the compressed composition is formed by the method according to any of the first-third aspects of the present invention.

According to a sixth aspect of the present invention therefore, there is provided an apparatus for manufacturing an elongate compressed detergent composition of a non-rectangular cross-section, comprising: at least one pressing means in movable communication with a forming chamber; the forming chamber being open to receive, in use, a dose of detergent composition to be compressed; said at least one pressing means having a contact surface suitable for contacting, in use, the dose of detergent composition to be compressed; said at least one contact surface being angled with respect to the forming chamber; said pressing means being operable to move in a substantially horizontal direction.

According to a seventh aspect of the present invention therefore, there is provided an apparatus for manufacturing an elongate compressed detergent composition, comprising: at least one pressing means in movable communication with a forming chamber; the forming chamber being open to receive, in use, a dose of detergent composition to be compressed; said at least one pressing means having a contact surface suitable for contacting, in use, the dose of detergent composition to be compressed; said at least one contact surface being angled with respect to the forming chamber; said pressing means being operable to move in a substantially horizontal direction; wherein at least one pair of opposite elongate sides of the resulting compressed composition are defined by one of said pair of sides being narrower that the other of said pair of sides.

Preferably the at least one contact surface is angled at a non-right angle relative to the direction of movement of the pressing means. Even more preferably the at least one contact surface comprises a plurality of angles, wherein at least one of said plurality of angles is at a non-right angle relative to the direction of movement of the pressing means.

Alternatively or additionally, the at least one contact surface is suitably angled such that after it has been brought into contact with a detergent composition and/or dose of detergent composition to be compressed, the resulting compressed detergent composition, is of a non-rectangular cross-section.

Preferably there are at least two pressing means in movable communication with the forming chamber. The at least two pressing means are separately or jointly provided with two contact surfaces. Where more than one contact surface is present, the contact surfaces are preferably operable, in use, on different sides of the resultant elongate compressed detergent composition, and preferably on substantially opposite sides of the resultant elongate compressed detergent composition.

The contact surface(s) may be operable, in use, to form one or more sides of the forming chamber. Preferably the contact surfaces form at least two sides of the forming chamber.

The contact surface(s) are preferably operable, in use, to contact the detergent composition to be compressed along an elongate portion thereof, i.e. contact on what will become the elongate side(s) of the resultant elongate compressed detergent composition.

In one particularly preferred embodiment of the present invention, the cross-section of the elongate compressed detergent composition is of one of the following shapes, namely: substantially pyramidal; substantially triangular; substantially tapered; of a substantially triangular prism; partially pyramidal; partially triangular; partially tapered; or of a partially triangular prism.

Additionally or alternatively, the cross-section of the elongate compressed detergent composition may comprise the majority of the features of a particular shape, such as substantially pyramidal for instance, and have one or more cross-sectional protrusions extending therefrom and thus altering the cross-sectional shape to being partially pyramidal for instance.

In a particularly preferred embodiment, the cross-section of the elongate compressed detergent composition is generally of a triangular prism wherein the sides thereof taper gradually from a base side to which they are both connected, then taper more abruptly until contacting each of at a point distal from the base side.

In the most preferred embodiment, the cross-section of the elongate compressed detergent composition is as illustrated in FIG. 4 of the specific embodiment.

Ideally the elongate compressed detergent composition is of substantially the same cross-section along its length.

The following definitions of elongate compressed detergent compositions (or “dosage elements”) of the invention apply both to dosage elements which are monolithic and to dosage elements constituted by two or more pieces set end-to-end.

In the latter embodiments the following definitions treat such dosage elements as if they were monolithic; for example length denotes the consolidated length, and surface area denotes the surface area of the dosage elements set end-to-end, not the summated surface area of the separated pieces.

Where the dosage elements are set end-to-end, they may be bonded together to more closely resemble a monolithic element, such bonding occurring by the application of compression forces and/or the application of an adhesive means.

Preferably the length (that is, the minimum length—see above) of a dosage element is at least 4 cm, preferably at least 5 cm, preferably at least 6 cm.

Preferably the length of a dosage element is up to 14 cm, preferably up to 12 cm, preferably up to 10 cm.

Preferably the thickness (that is, the maximum thickness see above) of a dosage element is at least 0.8 cm, preferably at least 1.4 cm, preferably at least 1.8 cm.

Preferably the thickness of a dosage element is up to 5 cm, more preferably up to 3.5 cm, more preferably up to 2.5 cm.

Preferably the cross-sectional area (that is, the maximum cross-sectional area—see above) of a dosage element is at least 0.6 cm², preferably at least 1 cm², preferably at least 1.5 cm².

Preferably the cross-sectional area of a dosage element is up to 5 cm², preferably up to 3.5 cm², more preferably up to 2.5 cm².

Preferably the surface area of a dosage element is at least 30 cm², preferably at least 35 cm², preferably at least 40 cm².

Preferably the surface area of a dosage element is up to 60 cm², preferably up to 55 cm², preferably up to 50 cm².

Preferably the volume of a dosage element is at least 6 ml, preferably at least 9 ml, preferably at least 12 ml.

Preferably the volume of a dosage element is up to 25 ml, preferably up to 20 ml, preferably up to 16 ml.

Preferably the weight of a dosage element is at least 8 g, preferably at least 12 g, preferably at least 15 g.

Preferably the weight of a dosage element is up to 32 g, preferably up to 26 g, preferably up to 24 g.

Preferably a dosage element has an aspect ratio (that is, the ratio of minimum length to maximum thickness—see above) of at least 2:1, preferably at least 2.5:1, preferably at least 3:1.

Preferably a dosage element has an aspect ratio of up to 12:1, preferably up to 8:1, preferably up to 6:1.

Preferably a dosage element has a ratio of length to cross-sectional area of at least 2:1, preferably at least 2.5:1, preferably at least 3:1 (units of length⁻¹).

Preferably a dosage element has a ratio of length to cross-sectional area of up to 12:1, preferably up to 8:1, preferably up to 6:1 (units of length⁻¹).

Preferably a dosage element has a ratio of surface area to volume of at least 1.5:1, preferably at least 2:1, preferably at least 3:1 (units of length⁻¹).

Preferably a dosage element has a ratio of surface area to volume of up to 8:1, preferably up to 6:1, preferably up to 4:1 (units of length⁻¹).

The dosage elements may be coated with a water-soluble protective layer, such as PVOH or any other suitable water-soluble protective layer.

According to an eighth aspect of the present invention therefore, there is provided a detergent composition comprising an elongate body with a substantially non-rectangular cross-section wherein said detergent composition has been formed by direct compression.

According to a ninth aspect of the present invention therefore, there is provided a detergent composition comprising an elongate body with a substantially pyramidal cross-section wherein said detergent composition has been formed by direct compression.

According to a tenth aspect of the present invention therefore, there is provided a detergent composition comprising an elongate body with at least one pair of opposite elongate sides of the composition being defined by one of said sides being narrower that the other of said sides, and wherein said detergent composition has been formed by direct compression.

### BRIEF DESCRIPTION OF THE DRAWINGS

Embodiments of the invention will now be described, by way of example only, with reference to the following drawings in which:

FIG. 1 shows one embodiment of a device according to the present invention;

FIG. 2 shows an alternative embodiment of a device according to the present invention;

FIG. 3 shows a perspective view of the pressing means used in the embodiment shown in FIG. 2;

FIG. 4 shows a perspective view of an alternative pressing means to that illustrated in FIG. 3;

FIG. 5 shows a rack of elongate compressed detergent compositions (or “dosage elements”) for use, with a multi-dosing detergent delivery device in a nested form, in a perspective view, generally from above;

FIG. 6 shows the article of FIG. 5 in nested form, in side view;

FIG. 7 shows the article of FIG. 5 in flattened form;

FIG. 8 shows the dosage element in perspective view;

FIG. 9a shows the article of FIG. 5 prior to being introduced into a multi-dosing detergent delivery device of FIG. 9b, the cap, containing the dosage element selecting device, being shown removed, as FIG. 9c;

FIG. 10 shows the article of FIG. 9a having been located within the holder of FIG. 9b;

FIG. 11 shows the fully assembled device, with the cap of FIG. 9c having been placed on the holder and article assembly of FIG. 10;

### DESCRIPTION OF AN EMBODIMENT

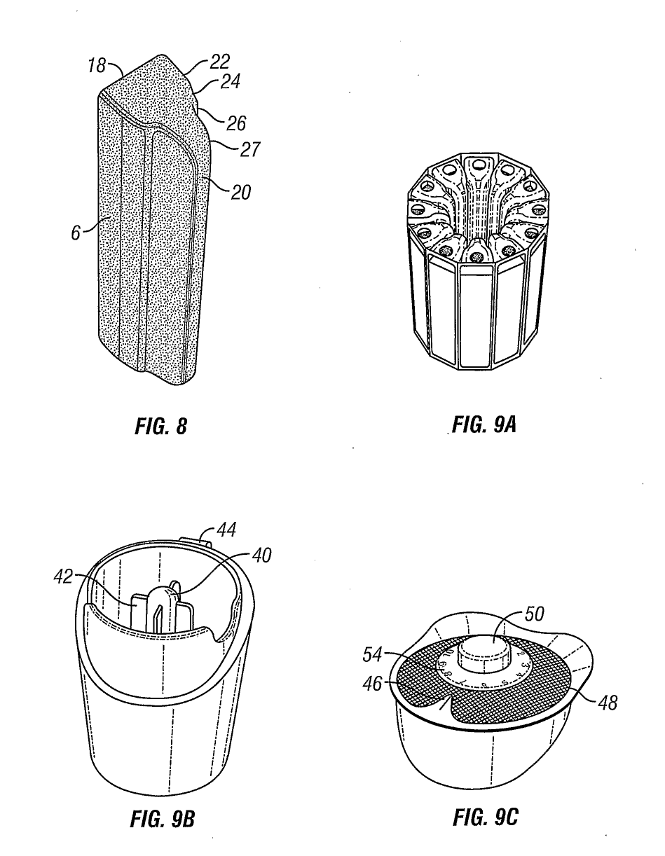

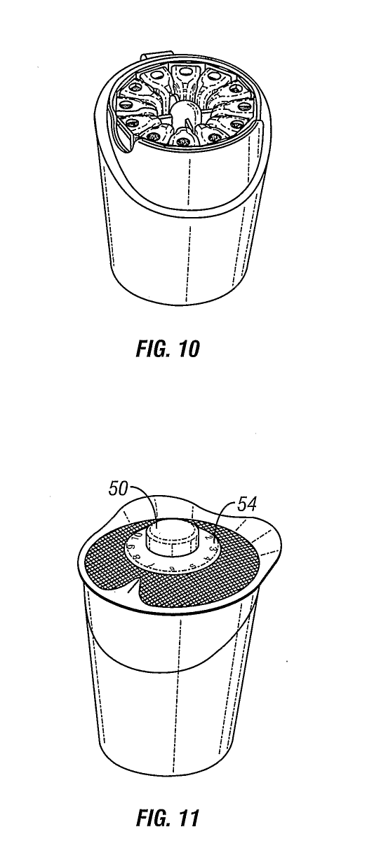

The aim of the methods of the present invention is to produce an elongate compressed detergent composition in the form of a dosage element suitable for use in a multi-dosing delivery device. One example of a resultant dosage element 6 is illustrated in FIG. 8.

One embodiment of the method of the present invention will be described with reference to FIG. 1. In FIG. 1 a forming chamber 60 that has been filled with a dose of detergent composition 61 is illustrated, the dose ideally being a predetermined quantity. In this embodiment the forming chamber 60 has three walls, two side walls 62,62′ that face each other and a third wall 63 joining the two side walls 62,62′. Walls 62,62′ are parallel to each other but with one wall 62 having a greater length than the other wall 62′, thus resulting in the third wall 63 having an angled orientation when viewed in plan as illustrated.

Spaced away from the forming chamber 60 is a pressing means 64. The pressing means 64 comprises a contact surface 65 and two separate side walls 66,66′. The contact surface 65 and side walls 66,66′ combine to form a head of the pressing means 64 and this is attached to or formed with a piston arm 67 which is in operable communication with a drive mechanism (not shown) which is adapted to cause movement of the pressing means 64 when in use.

The distance between the side walls 66,66′ of the pressing means head are similar but smaller than the distance between the side walls 62,62′ of the dosage chamber.

In this embodiment, walls 66,66′ are parallel to each other but with one wall 66′ having a greater length than the other wall 66, thus resulting in the contact surface 65 having an angled orientation when viewed in plan as illustrated.

In use, the detergent composition 61 is loaded, into the forming chamber 60 as illustrated in FIG. 1. The drive mechanism then urges the pressing means 64 toward the chamber 60. The contact surface 65 will contact the detergent 61 and begin the compression of same. The pressing means is able to enter the forming chamber 60 with side walls 66,66′ of the pressing means head moving in close proximity to the side walls 62,62′ of the forming chamber, preferably with as little gap as possible to prevent the erroneous release of detergent.

The distance moved by the pressing means 64 is predetermined such that a suitable compression force is imparted on the detergent composition 61 between the contact surface 65 and the walls 62,62′,63 of the forming chamber to produce a dosage element 6 of a desired level of compaction.

As can be seen in plan in FIG. 1, the angle of the forming chamber wall 63 and the contact surface 65 will result in a dosage element of a substantially pyramidal cross-section being produced. Although not shown in FIG. 1, the walls and contact surface are of an elongate height in order to produce the resultant elongate dosage element 6.

Although movement of the pressing means in a horizontal direction is preferred, the apparatus could be orientated such that the method operates to require vertical/downward movement of the pressing means into the forming chamber and detergent composition.

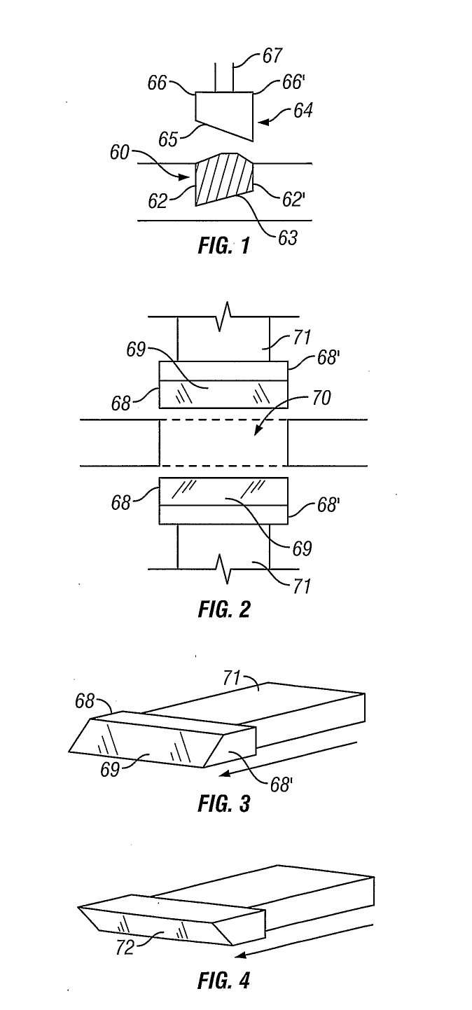

An alternative orientation of the contact surface of the pressing means is illustrated in FIGS. 2-4. In this preferred embodiment, the method is designed to operate with movement of two separate pressing means in a substantially horizontal direction.

As can be seen in FIG. 2-3, the head of the pressing means is provided with two side walls 68,68′ of a substantially equal length and the contact surface 69 is angled to form a slope or wedge shape.

In FIG. 2 two separate pressing means are illustrated spaced to opposite sides of a forming chamber 70. Both pressing means are in operable communication with one or more drive mechanisms such that the pressing means can be urged toward each other simultaneously.

Whilst non-simultaneous movement of the two pressing means may offer an alternative mode of operation, simultaneous movement is preferred.

In use, detergent composition (not shown) is loaded into the forming chamber 70 and a drive mechanism(s) urges the two separate pressing means toward each other and the chamber 70. The contact surfaces 69 will contact the detergent and begin the compression thereof. Similarly, the pressing means are able to enter the forming chamber 70 with side walls 68,68′ of the pressing means head moving in close proximity to the side walls of the forming chamber, preferably with as little gap as possible to prevent the erroneous release of detergent.

The distance moved by the two pressing means are preferably equal, albeit in opposite directions to each other, and predetermined such that a suitable compression force is imparted on the detergent composition between the contact surfaces 69 and the walls of the forming chamber to produce a dosage element 6 of a desired level of compaction.

The method of operation may permit multiple compressions to be applied to a single dose of detergent composition.

Whilst it is preferable for the pressing means to apply sufficient compressive force to a detergent composition to produce a dosage element 6, the method may be adapted such that the pressing means retract away from the partially compressed detergent composition and are subsequently urged toward the composition again to apply a further compressive force thereto.

The application of further compressive force may be the application of a greater force than applied in the first application or earlier application if the method involves more than two applications of compressive force.

Once the dosage element 6 has been formed, the retraction of the pressing means from the forming chamber will leave the dosage element 6 in the chamber. The dosage element 6 can be removed from the chamber by any suitable means, such as an extraction means which is capable of entering the chamber to push or pull the element 6 therefrom. Alternatively, the base of the forming chamber may have a tilt mechanism incorporated therein to permit the element 6 to slide or flip out of the chamber.

Although not shown, the forming chamber 70 may be provided with a cover which may result in the forming chamber 70 defining a channel. Said channel comprising an opening having two side walls, a cover at an upper part and a base at a lower part. In this arrangement, the side walls 68,68′ and upper and lower sides of the pressing means heads in FIGS. 2-4 are preferably sized to substantially closely fill the channel defined by the forming chamber 70. In this arrangement, when the two contact surfaces are urged toward each other, compression of the detergent composition is affected between the surfaces 69, the side walls, base and cover of the forming chamber 70.

The cover may be provided with a loading hatch to permit access therethrough thus facilitating the loading of detergent composition into the forming chamber 70.

FIG. 4 illustrates an alternative arrangement of the slope or wedge-shaped contact surface 69 shown in FIG. 3. Whereas the contact surface 69 in FIGS. 2-3 has what could be referred to as an upward slope, in the arrangement of FIG. 4, the contact surface 72 angled oppositely to form a concave slope. Similarly, there may be two separate pressing means as illustrated in FIG. 4 used is shown in FIG. 2, these pressing means being urged toward each other to cause the compression of detergent composition therebetween.

The angle of the contact surfaces 69,72 will result in a dosage element of a substantially pyramidal cross-section being produced. As shown in plan in FIG. 2, the contact surfaces 69,72 are elongate and thus adapted to produce the resultant elongate dosage element 6.

It is envisaged that the use of horizontal movement of the pressing means will be particularly advantageous. Specifically, it is envisaged that the use of two separate pressing means moving toward and away from each other will substantially improve the speed and efficiency of the process. Furthermore, it is also envisaged that more reliable compression can be applied to the detergent composition, thus producing more uniform dosage elements 6.

Although movement of the pressing means in a horizontal direction is preferred, the apparatus could be orientated such that the method operates to require vertical/downward movement of the pressing means into the forming chamber and detergent composition.

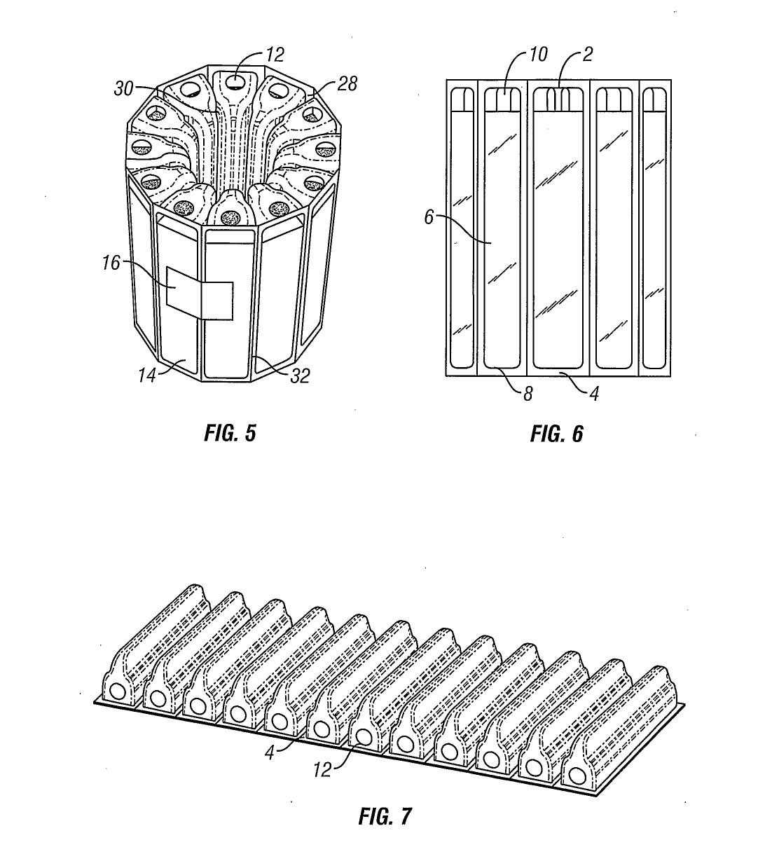

A rack of dosage elements 6 of FIG. 5 is manufactured as a flat plastics tray of elongated blister pockets 2, shown in FIGS. 6 & 7, comprising a thermoformed plastics tray. The open end of each blister pocket 2 is formed all around its perimeter with an endless flange 4 (which can be seen in FIGS. 6 & 7). Dosage elements 6, resembling solid rods or sticks (intended in this embodiment to be used for detergent in an automatic dishwasher machine), are introduced into the blister pockets 2.

The dosage elements 6 are manufactured by direct compression, as discussed above, and then introduced into the pockets. It may be noted that the dosage elements 6 are introduced into the pockets to fill each pocket to the bottom end 8, but to leave a space 10 at the top end. This space 10 is left so that water can enter the pocket, via opening 12 in the upper end wall of the pocket and, as is discussed later, may also help in providing complete dissolution of detergent composition within a reduced time period. In this embodiment each such opening 12 is circular, and 8 mm in diameter. An identical opening (not shown) is formed in the lower end wall of the article, to allow water and entrained or dissolved detergent composition to exit the pocket.

Once all of the pockets have been provided with the dosage elements 6 a backing sheet 14 is laid over the open ends, and secured to the flanges 4. The backing may be adhered thereto by any convenient means, for example by heat or adhesive.

Next, the flat article, now in the form of a rack or linear array of dosage elements, may be curled into its nested form shown in FIG. 5. In this embodiment the nested form is a generally cylindrical array. It may be retained in its nested form by a piece of adhesive tape 16.

The backing may be printed on its outwards-facing side with information, for example a trade mark, with product get-up, and/or with usage information.

As shown in FIG. 8, each dosage element 6 and correspondingly each blister, has a flat base wall 18 abutting the backing sheet 14. From the base wall 18, each dosage element 6, and each blister, generally tapers to a narrower distal end wall 20. The side walls initially taper gradually, as at 22, 24, then undergo a somewhat abrupt inward dislocation 26, then taper at an intermediate rate (between that of the side wall portion 22 and the dislocation 26) at 27, until the distal end wall 20 is reached.

The dosage elements 6 may be regarded as having the general shape of a triangular prism (i.e. trigonal). To be more precise, as noted above the side walls taper in a discontinuous manner.

It will be noted that the dosage elements 6 are located on the backing sheet with a separation 28 between them, at their base walls 18.

It may further be noted that the dosage elements 6 have a separation 30 between them, at their distal end region, when in their nested form.

The backing sheet has, as a result of the mould into which it is thermoformed during manufacture, preferential fold lines 32. These fold lines 32 are aligned with the spacings 28 between the dosage elements 6.

The end result of these features is as follows, and can be clearly seen in FIG. 5: when the article is formed into its nested shape the backing sheet is displaced about its 20, fold lines 22, in an articulated manner. This nesting or folding is permitted by the spacings 28 and 30; if the dosage elements 6 simply abutted against each other the operation would not be permitted, due to physical obstruction. As can be seen in FIG. 5 the spacings 30 in the distal end regions may remain even in the nested form (though obviously narrowed).

In use, the rack of dosage elements 6 is a refill which is supplied in its nested form shown in FIG. 5, and also FIG. 9a. In that nested form it is inserted into a holder, shown in FIG. 9b. The holder is a cylindrical tub having a hub-like axial projection 40 extending upwards from its base substantially the whole axial length of the tub.

Projecting outwardly from the projection 40 are four fins 42, set at 90° intervals. The fins extend approximately four-tenths of the radial distance of the holder.

The holder may have a hanging handle 44 and the bottom wall of the holder preferably has a large opening (not shown).

The holder has a lid shown in FIG. 9c. The lid defines a water/wash liquor collection area which extends across substantially a full upper surface area of the lid (in other words, across substantially the full cross-sectional area of the cylindrical device) and has a″central indexing device 46 surrounded by a sieve 48, to allow particulate free water to enter the holder. The central indexing device has a push button 50 and, around it, a dial 54 carrying numbers, equaling the number of rods or sticks of detergent composition. Each time the dishwasher is be used, the user presses the button to advance the control dial by one number, bringing the next rod or stick of detergent into use. This is done by rotating an apertured disc within the lid by one position so that water entering the holder is directed via directing means comprising the aperture thereof, now in alignment with the next rod or stick. Water enters the appropriate blister through the opening 12 which is aligned with the opening within the lid. The water may fill the spacing 10 above a dosage element 6. The dosage element 6 is soaked by the water and dissolves and/or crumbles away, leaving the blister through the bottom opening.

Somewhat surprisingly, it has been found that excellent dissolution of the dosage elements 6 is achieved by this method. It might have been expected that dissolving dosage elements 6 of the detergent composition by directing water to one end of them in an axial or lengthwise direction might be an inefficient method. In fact, dissolution or dispersion is excellent and the arrangement is very space-efficient, in not taking up very much of the “footprint area” available within the dishwashing machine.

In determining the minimum footprint of the device, a number of factors are involved. Firstly, it is generally the case that for an efficient detergent cycle to be carried out by a dishwasher a dosage element should contain between 15 and 25 g of detergent composition. For efficient working within the device of the present invention, an average density of the composition is set within the range of 1.0 to 1.5 g/cm³ and the preferred hardness of the composition is between 100 N-400N.

In arriving at required dimensions for the device, dishwasher environments were analyzed for flow of water/wash liquor and it was found that, in general, water flow rates within a dishwasher are in the range of 1 g of water to 15 g of water per square centimeter per minute.

Tests have shown that standard dishwashing detergent compositions (detergents) show a complete dissolution after 5 to 20 minutes in a standard dissolution test comprising complete immersion of detergent in water, at 40° C., under mechanical action.

Where a detergent composition having a 10 minute standard dissolution time is utilised, a minimal water flow of 200 g of water per minute is required through a chamber, whereas for a 20 minute standard dissolution time detergent composition, a 500 g per minute water flow has been found to be required. Preferably the device herein described utilises a detergent composition having a standard dissolution time of 5 minutes.

It has been found that a device which can collect and direct by any means a minimum of 50 g of water per minute into a chamber is able: to dissolve a detergent composition having a standard dissolution time of 5 minutes therein in a 50° C. normal programme.

It is desirable for the device to function when placed anywhere within a the dishwasher in which a minimum amount of water is available to it, and so it has been assumed that perhaps only 1 g water per minute per square cm is available. With this in mind, to assure that said water collection area is sufficient to provide 50 g of water per minute, a water collection area of 50 cm² is desirable, meaning a cylindrical device will require a diameter of approximately 8 cm². Whilst the foregoing may be the optimum dimensions for the device, it will be appreciated that the present invention may be seen to cover a range of devices with differing dimensions with, for instance, water collection areas in the range of 30 cm² to 8.0 cm² and that where high flow rates of water/wash liquor are known to be present a device having reduced dimensions may be utilised. Most preferably, the ratio of said water collection area to detergent composition standard dissolution time is within the range of 5 to 50 and, particularly in the range of 10 to 30.

Where we refer to standard dissolution times, what is meant is the time to take for the detergent composition to be substantially completely disintegrated in a given test environment. In such a test dosage elements are provided in separate metal cages and mechanically agitated in 40° C. water. The dosage elements are, in fact, not completely dissolved as such as they contain some water insoluble ingredients, therefore we can not speak about complete dissolution but “standard dissolution” which equates here to complete disintegration.

It has surprisingly been found that the dissolution of detergent composition within the device is aided when each dosage element is housed within a chamber having a larger volume than the detergent composition stored within it—hence the spacing 10 above the rod or stick—and it may also be desirable to provide a spacing between a lowermost part of the detergent composition stick and the bottom of its respective outer sleeve. Dissolution is particularly improved when the volume of the chamber does not exceed the volume of the dosage element by more than 40% and most preferably when the volume of the chamber exceeds the volume of the dosage element by between 15 and 20%.

As can be seen in FIG. 6a, when the article is located within the tub of the holder the fins 42 are located within spacings 30 of the nested article. The tolerance of the fins in the spacings 30 is not large and in this way it is assured that the dosage elements 6 and the upper openings 12 are in the correct orientation to align with the opening within the lid. FIG. 11 shows the fully assembled device.

As will be apparent to the skilled man, many variations may be made to the device without departing from the scope of the present invention. For instance, whilst the features of the water collection area and optimisation of dissolution characteristics have been discussed in relation to a mechanically user advanced device, these characteristics may advantageously be applied equally to other types of multi-dosing device, such as devices having an automatic advance mechanism between washes.

1. A method of manufacture of an elongate compressed detergent composition, using apparatus comprising at least one pressing means in movable communication with a forming chamber, wherein said at least one pressing means has a contact surface suitable for contacting, in use, a composition to be compressed, and wherein the at least one contact surface is angled with respect to the forming chamber; the method comprising the steps of:
loading the forming chamber with a dose of the detergent composition;
the at least one contact surface being brought into contact with the detergent composition;
the at least one pressing means compressing the composition between the at least one contact surface and forming chamber; and
retracting the at least one pressing means to leave an elongate compressed detergent composition in the forming chamber of a non-rectangular cross-section.

2. A method of manufacture of an elongate compressed detergent composition, using apparatus comprising at least one pressing means in movable communication with a forming chamber, wherein said at least one pressing means has a contact surface suitable for contacting, in use, a composition to be compressed, and wherein the at least one contact surface is angled with respect to the forming chamber; the method comprising the steps of:
loading the forming chamber with a dose of the detergent composition;
the at least one contact surface being movable in a substantially horizontal direction to be brought into contact with the detergent composition;
the at least one pressing means compressing the composition between the at least one contact surface and forming chamber; and
retracting the at least one pressing means to leave an elongate compressed detergent composition in the forming chamber of a non-rectangular cross-section.

3. A method of manufacture of an elongate compressed detergent composition, using apparatus comprising at least one pressing means in movable communication with a forming chamber, wherein said at least one pressing means has a contact surface suitable for contacting, in use, a composition to be compressed, and wherein the at least one contact surface is angled with respect to the forming chamber; the method comprising the steps of:
loading the forming chamber with a dose of the detergent composition;
the at least one contact surface being brought into contact with the detergent composition;
the at least one pressing means compressing the composition between the at least one contact surface and forming chamber;
retracting the at least one pressing means to leave an elongate compressed detergent composition in the forming chamber; and
wherein at least one pair of opposite elongate sides of the compressed composition are defined by one of said pair of sides being narrower that the other of said pair of sides.

4. The method according to claim 1, wherein the at least one contact surface is angled at a non-right angle relative to the direction of movement of the pressing means.

5. The method according to claim 1, wherein the at least one contact surface comprises a plurality of angles, wherein at least one of said plurality of angles is at a non-right angle relative to the direction of movement of the pressing means.

6. The method according to claim 1, wherein there are at least two pressing means in movable communication with the forming chamber.

7. The method according to claim 6, wherein the contact surfaces are operable, in use, on different sides of the resultant elongate compressed detergent composition, and preferably on substantially opposite sides of the resultant elongate compressed detergent composition.

8. The method according to claim 1, wherein the contact surface(s) are operable, in use, to contact the detergent composition to be compressed along an elongate portion thereof.

9. An elongate compressed detergent composition of a substantially non-rectangular cross-section, whereby the compressed composition is formed by the method according to claim 1.

10. An elongate compressed detergent composition wherein at least one pair of the elongate sides of the compressed composition are defined by one of said pair of sides being narrower that the other of said pair of sides; and whereby the compressed composition is formed by the method according to claim 1.

11. An apparatus for manufacturing an elongate compressed detergent composition of a non-rectangular cross-section, comprising: at least one pressing means in movable communication with a forming chamber; the forming chamber being open to receive, in use, a dose of detergent composition to be compressed; said at least one pressing means having a contact surface suitable for contacting, in use, the dose of detergent composition to be compressed; said at least one contact surface being angled with respect to the forming chamber; said pressing means being operable to move in a substantially horizontal direction.

12. An elongate compressed detergent composition, comprising: at least one pressing means in movable communication with a forming chamber; the forming chamber being open to receive, in use, a dose of detergent composition to be compressed; said at least one pressing means having a contact surface suitable for contacting, in use, the dose of detergent composition to be compressed; said at least one contact surface being angled with respect to the forming chamber; said pressing means being operable to move in a substantially horizontal direction; wherein at least one pair of opposite elongate sides of the resulting compressed composition are defined by one of said pair of sides being narrower that the other of said pair of sides.

13. A detergent composition comprising an elongate body with a substantially non-rectangular cross-section wherein said detergent composition has been formed by direct compression.

14. A detergent composition comprising an elongate body with a substantially pyramidal cross-section wherein said detergent composition has been formed by direct compression.

15. A detergent composition comprising an elongate body with at least one pair of opposite elongate sides of the composition being defined by one of said sides being narrower that the other of said sides, and wherein said detergent composition has been formed by direct compression.

16. The method according to claim 2, wherein the at least one contact surface is angled at a non-right angle relative to the direction of movement of the pressing means.

17. The method according to claim 2, wherein the at least one contact surface comprises a plurality of angles, wherein at least one of said plurality of angles is at a non-right angle relative to the direction of movement of the pressing means.

18. The method according to claim 2, wherein there are at least two pressing means in movable communication with the forming chamber.

19. The method according to claim 18, wherein the contact surfaces are operable, in use, on different sides of the resultant elongate compressed detergent composition, and preferably on substantially opposite sides of the resultant elongate compressed detergent composition.

20. The method according to claim 2, wherein the contact surface(s) are operable, in use, to contact the detergent composition to be compressed along an elongate portion thereof.

21. The method according to claim 3, wherein the at least one contact surface is angled at a non-right angle relative to the direction of movement of the pressing means.

22. The method according to claim 3, wherein the at least one contact surface comprises a plurality of angles, wherein at least one of said plurality of angles is at a non-right angle relative to the direction of movement of the pressing means.

23. The method according to claim 3, wherein there are at least two pressing means in movable communication with the forming chamber.

24. The method according to claim 23, wherein the contact surfaces are operable, in use, on different sides of the resultant elongate compressed detergent composition, and preferably on substantially opposite sides of the resultant elongate compressed detergent composition.

25. The method according to claim 2, wherein the contact surface(s) are operable, in use, to contact the detergent composition to be compressed along an elongate portion thereof.
